(19) United States
(12) Patent Application Publication
(10) Pub. No.: US 2023/0036887 A1
(43) Pub. Date: Feb. 2, 2023

(54) GEARING AND CRANKSHAFT ASSEMBLY FOR POWER TOOLS

(71) Applicant: Snap-on Incorporated, Kenosha, WI (US)

(72) Inventor: Joshua M. Beer, Kenosha, WI (US)

(73) Assignee: Snap-on Incorporated, Kenosha, WI (US)

(21) Appl. No.: 17/391,206

(22) Filed: Aug. 2, 2021

(51) Int. Cl. B25B 21/00; B25B 13/46

(52) U.S. Cl. CPC B25B 21/004; B25B 13/463

(57) ABSTRACT

A gearing and crankshaft assembly for a powered hand tool including an integrated gear carrier and crankshaft including first and second opposing ends, where the first end includes an offset pin, gears rotatably coupled to the integrated gear carrier and crankshaft by gear pins, bearings adapted to receive the integrated gear carrier and crank shaft to allow the integrated gear carrier and crank shaft to rotate relative to the driver portion, and a gear cover coupled to the driver portion and adapted to restrict axial movement of the gears.

### TECHNICAL FIELD OF THE INVENTION

The present invention relates generally to power tools. More specifically, the present invention relates to a gearing and crankshaft assembly for hand-held powered ratchet tools.

### BACKGROUND OF THE INVENTION

Power tools, such as, for example, motorized ratchet wrenches, drills, and drivers, driven by electric or pneumatic motors are commonly used in automotive, industrial, and household applications to tighten and untighten work pieces, such as threaded fasteners, and to apply a torque and/or angular displacement to a work piece, for example. Power tools, such as cordless power ratchets and drivers, generally include an electric motor contained in a housing, along with other components, such as switches, controllers, light emitting diodes (LEDs), and batteries, for example. The housing may be a clamshell type housing that generally includes two or more housing portions coupled together by fasteners, such as screws, rivets, glue or latches, to cooperatively form the housing.

Conventional power ratchet tools have gearing and crank shaft assemblies to transfer rotational motion of the motor to a ratchet mechanism. However, these tools have a gear carrier that is usually connected to a crankshaft through a spline or similar coupling. This causes the tool to be longer to accommodate the coupling components, thereby make use of the tool difficult in areas with limited space.

Other conventional power ratchet tools have integrated crankshaft and gear carriers. However, these tools utilize ball bearings disposed around the crankshaft to rotate relative to the ratchet housing, which requires the ratchet housing to be enlarged to accommodate the diameter of the balls used in the ball bearings.

### SUMMARY OF THE INVENTION

The present invention relates broadly to a gearing and crankshaft assembly for powered ratchet tools. The gearing and crankshaft assembly includes an integral gear carrier and crankshaft rotatably supported by needle roller bearings in the ratchet housing. The integral gear carrier and crankshaft includes apertures adapted to support gears operably coupled to a motor output shaft in a cantilevered manner. Since needle roller bearings do not use an internal race, as required with ball bearings, the outside diameter of a needle roller bearing is significantly smaller and has greater static load capacity, compared ball bearings. For example, a needle roller bearing for a 17 mm shaft has a static load rating of 2,300 pounds and a 23 mm outside diameter. A comparable ball bearing for the same 17 mm shaft has a static load carrying ability of 730 pounds and a 35 mm outside diameter. Accordingly, the present invention results in a more compact tool that is easier to manufacture and capable of significantly higher loads compared to current solutions.

In an embodiment, the present invention broadly comprises a tool having a driver portion coupled to a housing portion. The tool including a gearing and crankshaft assembly disposed in the driver portion. The assembly including an integrated gear carrier and crankshaft including first and second opposing ends, where the first end includes an offset pin, gears rotatably coupled to the integrated gear carrier and crankshaft by gear pins, bearings adapted to receive the integrated gear carrier and crank shaft to allow the integrated gear carrier and crank shaft to rotate relative to the driver portion, and a gear cover coupled to the driver portion and adapted to restrict axial movement of the gears.

In another embodiment, the present invention broadly comprises a gearing and crankshaft assembly for a tool. The assembly including an integrated gear carrier and crankshaft including first and second opposing ends, wherein the first end includes an offset pin, gears rotatably coupled to the integrated gear carrier and crankshaft by gear pins, bearings adapted to receive the integrated gear carrier and crank shaft to allow the integrated gear carrier and crank shaft to rotate, and a gear cover adapted to restrict axial movement of the gears.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplary power ratchet hand-tool, such as a motorized ratchet tool, that includes a gearing and crankshaft assembly, according to an embodiment of the present invention.

FIG. 2 is a plan view of a driver portion of the tool of FIG. 1, with a cover removed to view the internal components of the tool, according to an embodiment of the present invention.

FIG. 3 is a perspective, exploded view of the gearing and crankshaft assembly, according to an embodiment of the present invention.

FIG. 4 is a plan view of the crankshaft of the gearing and crankshaft assembly, according to an embodiment of the present invention.

FIG. 5 is another plan view of the crankshaft of the gearing and crankshaft assembly, according to an embodiment of the present invention.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a gearing and crankshaft assembly for powered motorized tools, such as, for example, powered ratchet tools. The gearing and crankshaft assembly includes an integral gear carrier and crankshaft rotatably supported by needle roller bearings in the ratchet housing. The integral gear carrier and crankshaft includes apertures adapted to support gears operably coupled to a motor output shaft in a cantilevered manner. Since needle roller bearings do not use an internal race, as required with ball bearings, the outside diameter of needle roller bearings is significantly smaller and has greater static load capacity, compared ball bearings. For example, a needle roller bearing for a 17 mm shaft has a static load rating of 2,300 pounds and a 23 mm outside diameter. A comparable ball bearing for the same 17 mm shaft has a static load carrying ability of 730 pounds and a 35 mm outside diameter. Accordingly, the present invention results in a more compact tool that is easier to manufacture and capable of significantly higher loads compared to current solutions.

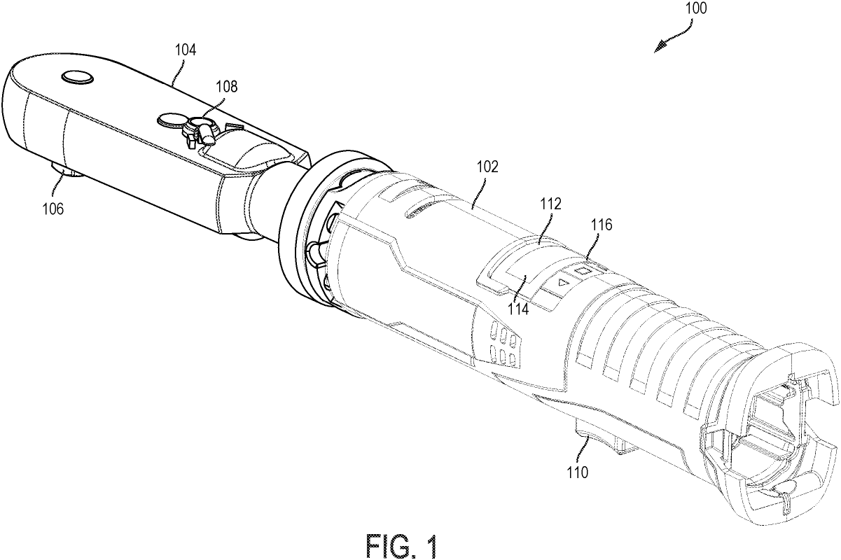

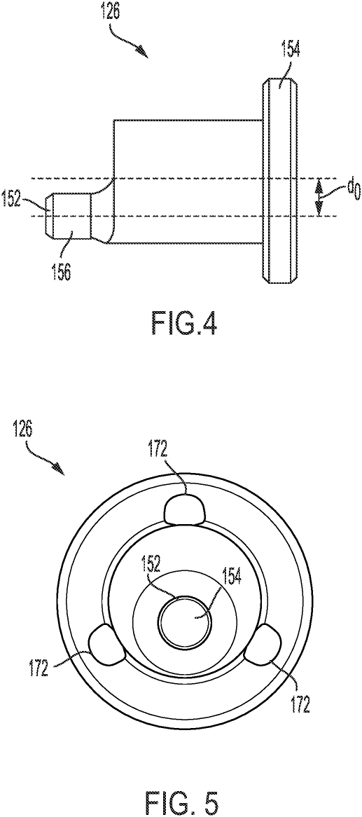

Referring to FIGS. 1-5, an exemplar powered ratchet tool 100, such as, for example, a motorized hand held tool, such as a ratchet wrench, drill, and/or driver, driven by an electric or pneumatic motor, includes a housing portion 102 adapted to be held by a user and a driver portion 104 coupled to the housing portion 102. The driver portion 104 is adapted to apply torque to a work piece and includes a drive lug 106 adapted to engage a tool (e.g., socket or bit) to drive the work piece, for example, in a well-known manner. The drive lug 106 is operatively coupled to and driven by a pneumatic or electric motor (not shown) via a ratcheting mechanism and a gearing and crankshaft assembly of the driver portion 104, described below. The driver portion 104 also includes a selector lever 108 adapted to select a desired rotational drive direction of the drive lug 106 (i.e., clockwise or counter-clockwise), as described below. For example, the driver portion 104 may be a ratchet head of a ratchet tool.

The housing portion 102 operably houses components of the tool 100, such as, for example, one or more of the motor adapted to drive the drive lug 106, a trigger 110 adapted to actuate the motor, a power source (not shown) adapted to provide power for the motor, such as, for example, a battery, controller(s), and/or a display assembly 112 (described below). In an embodiment, the housing portion 102 is assembled from two or more clamshell housing portions coupled together to cooperatively form the housing portion 102 and couple to the driver portion 104, thereby enclosing the components within the housing portion 102. The clamshell housing portions may be coupled together with any well-known manner, such as, for example, screws, rivets, glue, or other fasteners. The housing portion 102 may also include or form a grip for a user to hold during operation of the tool 100.

The motor can be operably coupled to the power source via the trigger 110 in a well-known manner. The power source can be external (e.g., an electrical wall outlet, generator, external battery, etc.) or internal (e.g., a removable and/or rechargeable battery). The trigger 110 can be adapted to selectively cause the motor to be turned ON and OFF, or cause electric power/voltage to flow from the power source to the motor or cease flow from the power source to the motor.

The trigger 110 can be an actuation mechanism that employs a push button type actuator or other type of actuator. For example, the user can depress trigger 110 inwardly to selectively cause power to be drawn from the power source and cause the motor to provide torque to the driver portion 104 in a desired rotational direction. Any suitable trigger 110 or switch can be implemented without departing from the spirit and scope of the present invention. For example, the trigger 110 can be a toggle actuator, a touch sensitive actuator, a slide actuator, or other suitable actuator or device. In another example, the trigger 110 can be biased such that the trigger 110 is inwardly depressible, relative to the housing portion 102, to cause the tool 100 to operate, and releasing the trigger 110 causes the trigger 110 to move outwardly, relative to the housing portion 102, to cease operation of the tool 100 via the biased nature of the trigger 110. The trigger 110 may also be a variable speed type mechanism. In this regard, relative actuation or depression of the trigger 110 causes the motor to operate at variable speeds the further the trigger 110 is depressed.

The display assembly 112 includes a display 114 adapted to indicate tool information to a user. In an embodiment, the display 114 is a LCD. Tool information can include, for example, status of the tool, such as, for example, a power level of the power source, a selected driving direction of the drive lug 106, a power state of the motor, battery charge or condition, output torque of the tool 100, etc. The display assembly 112 may further include one or more buttons 116 adapted to receive user input, such as, for example, selecting what is displayable on the display 114, for selecting tool parameters, such as, for example, the driving direction of the drive lug 106 or torque output, and/or for otherwise manipulating the display 114 to control the tool 100 and/or parameters of the tool 100.

The ratchet mechanism is disposed in the driver portion 104. The ratchet mechanism includes a link member 118, first 120 and second 122 pawls, and a ratchet gear 124. The ratchet mechanism operably couples the drive lug 106 to the motor to be driven thereby when the trigger 110 is actuated.

The link member 118 includes an aperture 128 adapted to receive a post 130 to rotatably couple the link member 118 to the driver portion 104. The post 130 may be integrally formed with the driver portion 104. The link member 118 may also include an opening 132. In an embodiment, the opening 132 is arcuately shaped. The opening 132 is adapted to rotatably couple to a bushing 134 that is adapted to receive an integrated gear carrier and crank shaft 126, as described below.

The first 120 and second 122 pawls respectively include first 136 and second 138 pivot apertures adapted to respectively receive a pin, shaft, axle, or fastener, to pivotably couple the first 120 and second 122 pawls to the link member 118. The first pawl 120 includes first pawl teeth 140 and a first finger portion 142. The second pawl 122 includes second pawl teeth 144 and a second finger portion 146.

The ratchet gear 124 includes a generally circular body portion 148 having circumferential toothed portion 150. The drive lug 106 may be coupled to or integral with the body portion 148. The toothed portion 118 selectively engages first 140 or second 144 pawl teeth for selective engagement with one of the first 120 and second 122 pawls to provide torque drive through the drive lug 106 in either of the first and second rotational drive directions, based on a position of the selector lever 108, as described below. The first 120 and second 122 pawls are each biased towards the ratchet gear by a biasing member 160, such as, for example, a spring.

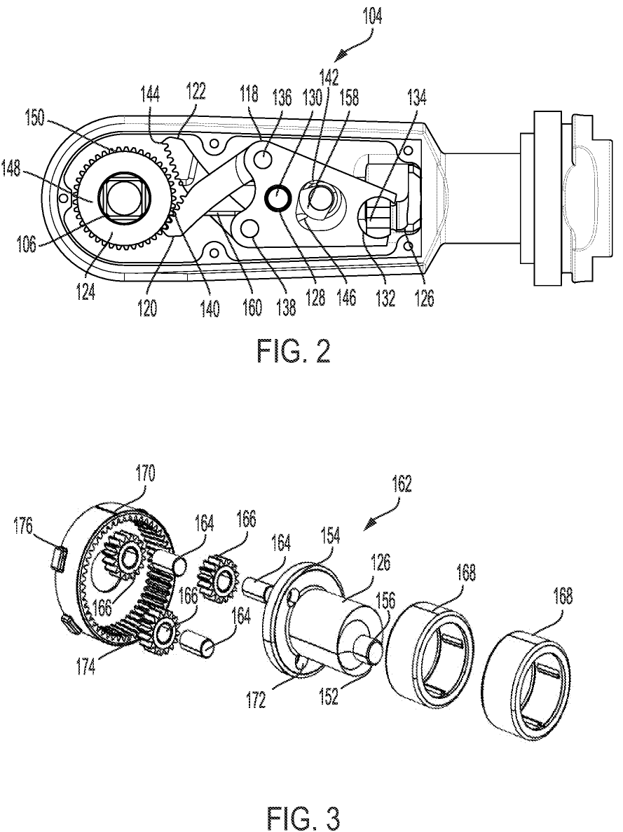

The selector lever 108 is pivotally coupled to a cam 158, such that the cam 158 co-rotates with the selector lever 108 to selectively position one of the pawls 120, 122 into engagement with the ratchet gear 124 for selecting the torque drive direction in either of the first and second rotational drive directions (i.e., clockwise and counterclockwise). For example, to select the first rotational drive direction, as illustrated in FIG. 2, the cam 158 is rotated via the selector lever 108 to abut the second finger portion 146 to overcome a bias force of the biasing member 160 to disengage the second pawl teeth 144 from the toothed portion 150 of the ratchet gear 124. To select the second rotational drive direction, the cam 158 is rotated via the selector lever 108 to abut the first finger portion 142 to overcome the bias force of the biasing member 160 to disengage the first pawl teeth 140 from the toothed portion 150 of the ratchet gear 124.

A gearing and crankshaft assembly 162 is disposed in the driver portion 104 and is adapted to operably couple the motor to the ratchet mechanism to transfer rotational motion of the motor to the ratchet mechanism. The gearing and crankshaft assembly 162 includes the integrated gear carrier and crankshaft 126, gear pins 164, gears 166, bearings 168, and a gear cover 170.

The integrated gear carrier and crank shaft 126 includes first 152 and second 154 opposing ends. The first end includes an offset pin 156. The offset pin 156 is received by the bushing 134 disposed in the opening 132 of the link member 118. The offset pin 156 is offset from a longitudinal axis of the crank shaft 126 at a distance d₀. The second end 154 includes apertures 172 adapted to respectively receive the pins 164 to support the gears 166 in a cantilevered manner and rotatably couple the gears 166 to the second end 154. In other words, only one end of each of the pins 164 are supported by the second end 154. The gear pins 164 have a substantially circular cross-section and are adapted to be received by the gears 166, thereby rotatably coupling the gears 166 to the integrated gear carrier and crank shaft 126. The gears 166 function as planet gears in a planetary gearing system. Although three gears 166 are shown, the invention is not limited as such and any suitable number of gears 166 may be used.

The bearings 168 receive the integrated gear carrier and crank shaft 126 and are adapted to allow the integrated gear carrier and crank shaft 126 to rotate relative to the driver portion 104. In an embodiment, the bearings 168 are needle roller bearings. In an embodiment, gearing and crankshaft assembly 162 includes two bearings 168. In another embodiment, the two bearings 168 are respectively disposed about equidistant from the respective first 152 and second 154 opposing ends, thereby equalizing load forces applied to the integrated gear carrier and crank shaft 126.

The gear cover 170 is coupled to the driver portion 104 and is adapted to restrict axial movement of the gears 166 relative to the driver portion 104. The gear cover 170 includes gear teeth 174 disposed along an internal circumferential surface of the gear cover 170 that are adapted to engage the gears 166, thereby functioning as a ring gear in a planetary gearing system. In an embodiment, the gear cover 170 includes radial protrusions 176 adapted to engage internal geometry of the driver portion 104 to restrict rotational movement of the gear cover 170 relative to the driver portion 104. Although four protrusions 176 are shown, the invention is not limited as such and any number of protrusions 176 may be used.

During operation, upon actuation of the trigger 110, the motor drives the integrated gear carrier and crank shaft 126 via the gears 166 to rotate about the longitudinal axis of the integrated gear carrier and crank shaft 126 to drive the link member 118 back and forth about post 130, thereby correspondingly moving the pawls 120, 122. Accordingly, one of the first and second pawls 120, 122 selectively engaged with the ratchet gear 124 will drive the drive lug 106 in the selected rotational direction (e.g., either clockwise or counterclockwise).

As discussed above, the aspects of the present invention are described in terms of a powered ratchet tool, as shown. However, it should be understood that aspects of the present invention could be implanted in other hand tools. For example, and without limitation, the hand tool can be a ratchet wrench, impact wrench, open wrench, screw driver, nut driver, drill, or any other tool capable of applying torque to a work piece.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors’ contribution. The actual scope of the protection sought is intended to be defined in the following claims when viewed in their proper perspective based on the prior art.

What is claimed is:

1. A tool having a driver portion coupled to a housing portion, comprising:
a gearing and crankshaft assembly disposed in the driver portion, the assembly including:
an integrated gear carrier and crankshaft including first and second opposing ends, wherein the first end includes an offset pin;
gears rotatably coupled to the integrated gear carrier and crankshaft by gear pins;
bearings adapted to receive the integrated gear carrier and crank shaft to allow the integrated gear carrier and crank shaft to rotate relative to the driver portion; and
a gear cover coupled to the driver portion and adapted to restrict axial movement of the gears.

2. The tool of claim 1 further comprising a ratchet mechanism including a link member rotatably coupled to the integrated gear carrier and crankshaft;
a ratchet gear having a toothed portion and adapted to be selectively driven in either of first and second drive directions;
first and second pawls pivotably coupled to the link member and adapted to selectively engage the toothed portion for selecting one of the first and second drive directions, wherein the first drive direction is selected when the first pawl is engaged with the toothed portion and the second pawl is disengaged from the toothed portion, and the second drive direction is selected when the first pawl is disengaged from the toothed portion and the second pawl is engaged with the toothed portion.

3. The tool of claim 1, wherein the second end of the integrated gear carrier and crankshaft includes apertures adapted to respectively receive the gear pins to support the gears in a cantilevered manner and rotatably couple the gears to the second end.

4. The tool of claim 1, wherein the gearing and crankshaft assembly includes three gears rotatably coupled to the integrated gear carrier.

5. The tool of claim 1, wherein the bearings are needle roller bearings.

6. The tool of claim 1, wherein the gearing and crankshaft assembly includes two bearings.

7. The tool of claim 1, wherein the gear cover includes gear teeth disposed along an internal circumferential surface of the gear cover and that are adapted to engage the gears.

8. The tool of claim 1, wherein the gear cover includes radial protrusions adapted to engage internal geometry of the driver portion.

9. The tool of claim 8, wherein the gear cover includes four protrusions.

10. A gearing and crankshaft assembly for a tool, comprising:
an integrated gear carrier and crankshaft including first and second opposing ends, wherein the first end includes an offset pin;
gears rotatably coupled to the integrated gear carrier and crankshaft by gear pins;
bearings adapted to receive the integrated gear carrier and crank shaft to allow the integrated gear carrier and crank shaft to rotate; and
a gear cover adapted to restrict axial movement of the gears.

11. The gearing and crankshaft assembly of claim 10, wherein the second end of the integrated gear carrier and crankshaft includes apertures adapted to respectively receive the gear pins to support the gears in a cantilevered manner and rotatably couple the gears to the second end.

12. The gearing and crankshaft assembly of claim 10, wherein the gearing and crankshaft assembly includes three gears rotatably coupled to the integrated gear carrier.

13. The gearing and crankshaft assembly of claim 10, wherein the bearings are needle roller bearings.

14. The gearing and crankshaft assembly of claim 10, wherein the gearing and crankshaft assembly includes two bearings.

15. The gearing and crankshaft assembly of claim 10, wherein the gear cover includes gear teeth disposed along an internal circumferential surface of the gear cover and that are adapted to engage the gears.

16. The gearing and crankshaft assembly of claim 10, wherein the gear cover includes radial protrusions adapted to engage internal geometry of a driver portion of the tool.

17. The gearing and crankshaft assembly of claim 16, wherein the gear cover includes four protrusions.
